(19) United States
(12) Patent Application Publication
(10) Pub. No.: US 2018/0204298 A1
(43) Pub. Date: Jul. 19, 2018

(54) INTERNET OF THINGS (IOT) ENHANCED TOOL SAFETY

(71) Applicant: International Business Machines Corporation, Armonk, NY (US)

(72) Inventors: Rick A. Hamilton, II, Charlottesville, VA (US); Agueda Martinez Hernandez Magro, Jalisco (MX); Jose Roberto Mosqueda Mejia, Michoacan (MX); Victor Adrian Sosa Herrera, Jalisco (MX)

(21) Appl. No.: 15/408,331

(22) Filed: Jan. 17, 2017

(51) Int. Cl. G06Q 50/20; G06K 7/10; H04W 4/00; G06K 19/07; G06K 19/077

(52) U.S. Cl. CPC G06Q 50/2057; G06K 7/10386; H04L 67/12; G06K 19/0723; G06K 19/07758; H04W 4/008

(57) ABSTRACT

Embodiments of the present invention provide a method, system and computer program product for Internet of things (IoT) enhanced tool safety. In an embodiment of the invention, a method for IoT enhanced tool safety includes establishing by an IoT server over a computer communications network a communicative coupling to a mobile device associated with an end user, receiving in the IoT server from the mobile device from over the communicative coupling an identifier of a tool in wireless communication with the mobile device, determining in the IoT server based upon the identifier if the end user associated with the mobile device has completed requisite training for using the tool and directing by the IoT server a prompting of the user in the mobile device to complete the requisite training prior to using the tool in response to a determination that the end user has not completed the requisite training.

### BACKGROUND OF THE INVENTION

### Field of the Invention

The present invention relates to mechanical and electric tools and more particularly to mechanical and electric tool safety.

### Description of the Related Art

Tools are instruments used by individuals to perform utilitarian tasks and include both manual instruments and electrically powered instruments. Common examples of manual instruments include screwdrivers, hammers and wrenches, whereas common examples of electrical instruments include powered drills and saws and powered screwdrivers. The Internet of Things, also known as “IoT” refers to the internetworking of physical devices, vehicles, buildings and other items that include embedded electronics, software, sensors, actuators, and network connectivity that enable these objects to collect and exchange data. As applied to tools, the IoT supports the communication of a tool with its manufacturer and more recently, the IoT allows for manufacturers to remotely adjust the settings and tolerances of connected tools and machines present on a production floor.

### BRIEF SUMMARY OF THE INVENTION

Embodiments of the present invention address deficiencies of the art in respect to tool safety and provide a novel and non-obvious method, system and computer program product for IoT enhanced tool safety. In an embodiment of the invention, a method for IoT enhanced tool safety includes establishing by an IoT server over a computer communications network a communicative coupling to a mobile device associated with an end user, receiving in the IoT server from the mobile device from over the communicative coupling an identifier of a tool in wireless communication with the mobile device, determining in the IoT server based upon the identifier if the end user associated with the mobile device has completed requisite training for using the tool and directing by the IoT server a prompting of the user in the mobile device to complete the requisite training prior to using the tool in response to a determination that the end user has not completed the requisite training.

In one aspect of the embodiment, the IoT server additionally, in response to the determination that the end user has not completed the requisite training, transmits to the tool over the computer communications network a command to apply an operable limitation upon access to the tool by the end user of the tool. In this regard, the operable limitation may include an inability to power the tool. However, the operable limitation may be removed subsequent to the IoT server determining that the end user has completed the requisite training. In another aspect of the embodiment, the tool is in wireless communication with the mobile device by a position of the mobile device upon a near field communication (NFC) controller of the tool, or by the mobile device reading a radio frequency identification (RFID) tag affixed to the tool, or by utilizing short range wireless communications.

In another embodiment of the invention, an IoT data processing system is provided. The system includes a host computing platform with one or more computers each with memory and at least one processor and communicatively coupled to a multiplicity of tools over a computer communications network and also a multiplicity of mobile devices over the computer communications network. The system also includes an IoT server operating in the host computing platform. Finally, the system includes an IoT enhanced tool safety module coupled to the IoT server. The module includes program code enabled upon execution in the memory of the host computing platform, to receive from one of the the mobile devices an identifier of a tool in wireless communication with the mobile device, to determine based upon the identifier if an end user associated with the mobile device has completed requisite training for using the tool, and to direct a prompting of the user in the one of the mobile devices to complete the requisite training prior to using the tool in response to a determination that the end user has not completed the requisite training.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for IoT enhanced tool safety;

FIG. 2 is a schematic illustration of a data processing system configured for IoT enhanced tool safety; and,

FIG. 3 is a flow chart illustrating a process for IoT enhanced tool safety.

### DETAILED DESCRIPTION OF THE INVENTION

Embodiments of the invention provide for IoT enhanced tool safety. In accordance with an embodiment of the invention, a mobile device of an end user communicatively connects with a tool and identifies the tool. The mobile device then provides the identification of the tool to a back end IoT server managing the tool. The back end IoT server determines if the end user has been sufficiently trained to use the tool. If not, the back end IoT server transmits a notification to the mobile device prompting the end user to complete online training in respect to the tool. Optionally, the IoT server limits access by the end user to the tool. Once the end user has completed online training, the IoT server then removes the imposed limitations by the end user upon the tool.

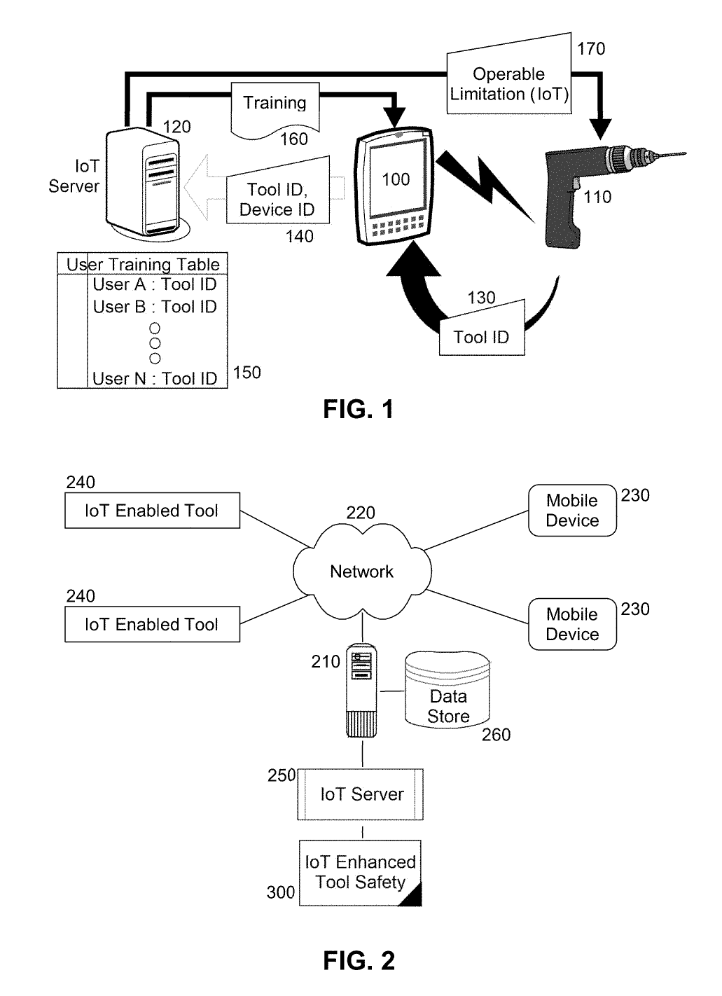

In further illustration, FIG. 1 pictorially shows a process for IoT enhanced tool safety. As shown in FIG. 1, a mobile device 100 such as a smart phone, table computer or personal digital assistant wireless connects to a tool 110 adapted for IoT and communicatively linked to an IoT server 120. The wireless connection may be NFC, short range wireless such as Bluetooth, or RFID to name three possibilities. The tool 110 upon connecting to the mobile device 100 provides to the mobile device 100 a tool identification 130. The mobile device 100 in turn transmits a message 140 to the IoT server containing both a mobile device identifier of the mobile device 100 and the tool identifier 130 received from the tool 110.

The IoT server 120 upon receiving the message 140 from the mobile device 100 determines in reference to a user training table 150 whether or not an end user associated with the mobile device 100 has satisfactorily completed the requisite training and education to utilize the tool 110 in a safe and proper manner. If not, the IoT server 120 transmits a message 160 to the mobile device 100 causing the mobile device 100 to display a prompt recommending the end user retrieve into the mobile device training and educational materials pertinent to the requisite to the safe and proper utilization of the tool 110. As well, the IoT server 120 transmits a directive 170 to the tool 110 inhibiting the operation of the tool 110, such as inhibiting a powering of the tool 110.

The end user then may download into the mobile device 100 the training and educational materials requisite to the safe and proper utilization of the tool 110. Optionally, the training and educational materials can be presented in an orderly fashion in the mobile device 100 as an online course in which the end user reviews textual and audiovisual materials and completes an online quiz successfully before being permitted to proceed from section to section of the online course. Alternatively, the training and educational materials are presented in a self-service fashion with the end user attesting to the complete and thorough review of the training and educational materials. In any event, once the end user has completed a review of the training and educational materials, the IoT server 120 is notified and the IoT server 120 updates the user training table 150 to indicate as much. Finally, the IoT server 120 removes the directive 170 inhibiting the operation of the tool 110.

The process described in connection with FIG. 1 may be implemented in a data processing system. In yet further illustration, FIG. 2 schematically shows a data processing system configured for IoT enhanced tool safety. The system includes a host computing platform 210 that includes one or more computers, each with memory and at least one processor. The host computing platform 210 is communicatively coupled over computer communications network 220 to a multiplicity of mobile devices 230 and also to a multiplicity of IoT enabled tools 240. The host computing platform 210 supports the operation of an IoT server 250. The IoT server 250 provides for communications and data storage in a data store 260 for acquired data from each of the IoT enabled tools 240 by way of a gateway (not shown). The IoT server 250 also provides for command and control of each of the IoT enabled tools 240 by way of the gateway in accordance with an application programming interface (API) of each of the IoT enabled tools 240.

Of import, an IoT enhanced tool safety module 300 is coupled to the IoT server 250 and executes in the memory of the host computing platform 210. The IoT enhanced tool safety module 300 includes program code enabled during execution to receive from a one of the mobile devices 230 a device identifier and an identifier of one of the IoT enabled tools 240 wirelessly connected to the one of the mobile devices 230. The program code then determines in reference in the data store 260 if an end user associated with the one of the mobile devices 230 has completed the requisite education and training for the wirelessly connected one of the IoT enabled devices 240. If not, the program code then directs a prompting in the one of the mobile devices 230 to retrieve and review materials for the requisite education and training and the program code directs the IoT server 250 to inhibit the operation of the wireless connected one of the IoT enabled devices 240 until such time as the end user has completed a review of the materials for the requisite education and training.

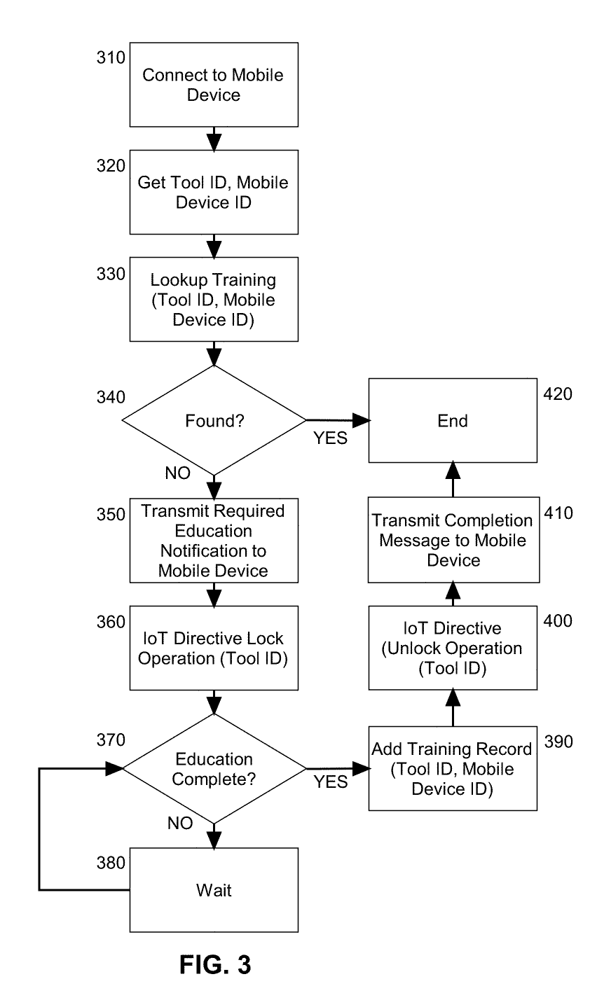

In even yet further illustration of the operation of the IoT enhanced tool safety module 300, FIG. 3 is a flow chart illustrating a process for IoT enhanced tool safety. Beginning in block 310, the IoT enhanced tool safety module 300 connects to a mobile device. In block 320, the IoT enhanced tool safety module 300 receives from the mobile device a tool identifier and a mobile device identifier associated with an end user. In block 330, the IoT enhanced tool safety module 300 attempts to locate in a table a record of the end user having completed the requisite training and education for a tool corresponding to the tool identifier. In decision block 340, if the record is found, the process ends in block 420. Otherwise, the process continues in block 350.

In block 350, the IoT enhanced tool safety module 300 transmits a message to the mobile device to prompt the end user to complete the requisite training and education for the tool. Optionally, the prompt can include a hyperlink to a location on the World Wide Web wherein the end user may review materials for the requisite training and education for the tool or wherein the end user may enroll and participate in an online course delivering in a structured fashion the materials for the requisite training and education for the tool. As another option, the mobile device may display one or more contractual agreements with which the user must agree and sign in order to power and operate the tool. As well, in block 360, the IoT enhanced tool safety module 300 directs the IoT server to issue a command to the tool to inhibit the operation of the tool by the end user.

In decision block 370, the IoT enhanced tool safety module 300 determines if the end user has completed the requisite training and education. If not, in block 380 the IoT enhanced tool safety module 300 may wait for attempting again to determine if the end user has completed the requisite training and education. If so, in block 390 the IoT enhanced tool safety module 300 then adds a record indicating that the end user has completed the requisite training and education for the tool. As well, in block 400 the IoT enhanced tool safety module 300 directs the IoT server to issue a command to the tool to remove the inhibition of the operation of the tool by the end user. In block 410, a message is then transmitted to the mobile device prompting the mobile device to display to the end user that the requisite training and education for the tool has been completed. Finally, the process ends in block 420.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for Internet of things (IoT) enhanced tool safety, comprising
establishing by an IoT server over a computer communications network a communicative coupling to a mobile device associated with an end user;
receiving in the IoT server from the mobile device from over the communicative coupling an identifier of a tool in wireless communication with the mobile device;
determining in the IoT server based upon the identifier if the end user associated with the mobile device has completed requisite training for using the tool; and,
directing by the IoT server a prompting of the user in the mobile device to complete the requisite training prior to using the tool in response to a determination that the end user has not completed the requisite training.

2. The method of claim 1, wherein the IoT server additionally, in response to the determination that the end user has not completed the requisite training, transmits to the tool over the computer communications network a command to apply an operable limitation upon access to the tool by the end user of the tool.

3. The method of claim 2, wherein the operable limitation is an inability to power the tool.

4. The method of claim 2, wherein the operable limitation is removed subsequent to the IoT server determining that the end user has completed the requisite training.

5. The method of claim 1, wherein the tool is in wireless communication with the mobile device by a position of the mobile device upon a near field communication controller of the tool.

6. The method of claim 1, wherein the tool is in wireless communication with the mobile device by the mobile device reading a radio frequency identification (RFID) tag affixed to the tool.

7. The method of claim 1, wherein the tool is in wireless communication with the mobile device utilizing short range wireless communications.

8. An Internet of things (IoT) data processing system comprising:
a host computing platform comprising one or more computers each with memory and at least one processor and communicatively coupled to a multiplicity of tools over a computer communications network and also a multiplicity of mobile devices over the computer communications network;
an IoT server operating in the host computing platform; and,
an IoT enhanced tool safety module coupled to the IoT server, the module comprising program code enabled upon execution in the memory of the host computing platform, to receive from one of the the mobile devices an identifier of a tool in wireless communication with the mobile device, to determine based upon the identifier if an end user associated with the mobile device has completed requisite training for using the tool, and to direct a prompting of the user in the one of the mobile devices to complete the requisite training prior to using the tool in response to a determination that the end user has not completed the requisite training.

9. The system of claim 8, wherein the IoT server additionally, in response to the determination that the end user has not completed the requisite training, transmits to the tool over the computer communications network a command to apply an operable limitation upon access to the tool by the end user of the tool.

10. The system of claim 9, wherein the operable limitation is an inability to power the tool.

11. The system of claim 9, wherein the operable limitation is removed subsequent to the IoT server determining that the end user has completed the requisite training.

12. The system of claim 8, wherein the tool is in wireless communication with the mobile device by a position of the mobile device upon a near field communication controller of the tool.

13. The system of claim 8, is in wireless communication with the mobile device utilizing short range wireless communications.

14. A computer program product for IoT enhanced tool safety, the computer program product comprising a computer readable storage medium having program instructions embodied therewith, the program instructions executable by a device to cause the device to perform a method comprising:
establishing by an IoT server over a computer communications network a communicative coupling to a mobile device associated with an end user;
receiving in the IoT server from the mobile device from over the communicative coupling an identifier of a tool in wireless communication with the mobile device;
determining in the IoT server based upon the identifier if the end user associated with the mobile device has completed requisite training for using the tool; and,
directing by the IoT server a prompting of the user in the mobile device to complete the requisite training prior to using the tool in response to a determination that the end user has not completed the requisite training.

15. The computer program product of claim 14, wherein the IoT server additionally, in response to the determination that the end user has not completed the requisite training, transmits to the tool over the computer communications network a command to apply an operable limitation upon access to the tool by the end user of the tool.

16. The computer program product of claim 15, wherein the operable limitation is an inability to power the tool.

17. The computer program product of claim 15, wherein the operable limitation is removed subsequent to the IoT server determining that the end user has completed the requisite training.

18. The computer program product of claim 14, wherein the tool is in wireless communication with the mobile device by a position of the mobile device upon a near field communication controller of the tool.

19. The computer program product of claim 14, wherein the tool is in wireless communication with the mobile device by the mobile device reading a radio frequency identification (RFID) tag affixed to the tool.

20. The computer program product of claim 14, wherein the tool is in wireless communication with the mobile device utilizing short range wireless communications.
